(19) United States
(12) Patent Application Publication
(10) Pub. No.: US 2006/0209486 A1
(43) Pub. Date: Sep. 21, 2006

(54) Method for determining the magnetic flux in at least one solenoid valve which can be electrically driven via a driver stage

(75) Inventors: Wolfgang Fey, Niedernhausen (DE); Mario Engelmann, Steinbach/Ts (DE); Micha Heinz, Darmstadt (DE); Wolfgang Joeckel, Obertshausen (DE); Axel Schmitz, Hattersheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/566,616

(22) PCT Filed: Jul. 28, 2004
(86) PCT No.: PCT/EP04/51636

§ 371 Date: Jan. 31, 2006

(30) Foreign Application Priority Data
Jul. 31, 2003 (DE) 103355863
Nov. 26, 2003 (DE) 103558365
May 13, 2004 (DE) 1020040240582

(51) Int. Cl. H01H 47/00

(52) U.S. Cl. 361/143

(57) ABSTRACT

Disclosed are a method and circuit arrangement for determining the magnetic flux in at least one inductive component (1) which is electrically drivable by way of an electronic actuation or driver stage (3) by means of a drive signal (6), by evaluation and adjustment of a measuring signal induced by the magnetic flux of the inductive component using an electronic measuring device (4), and the magnetic-flux-responsive measuring signal (5) measured at the inductive component is actively maintained at a substantially constant value by means of the measuring device or the electronic actuation or the driver stage (3), and the time (t₁, t_{c}) is determined during which the drive signal is triggered, which acts on the inductive component with production of the measuring signal.

### BACKGROUND OF THE INVENTION

The present invention relates to a method and an electronic circuit arrangement for determining the magnetic flux in at least one inductive component which is electrically drivable by way of a driver stage and, preferably, is an electromagnetically drivable valve or slide (actuator), as well as the implementation of the method and the circuit arrangement in a method for the calibration or mechanical adjustment or calculation of a drive current.

It is known in prior art to employ electromagnetically operable analogized valves for the precise control of the hydraulic pressure in ABS control units for motor vehicle brake systems but also in so-called driving dynamics controllers equipped with additional functions such as ESP, etc.

So-called analog/digital valves are used in up-to-date generations of hydraulic control units. An analog/digital valve is a switching actuator which is so operated that it has analog control properties. The valve is designed in such a manner that it allows both analog and digital operation.

EP 0 813 481 B1 (P 7565) discloses a method for the detection of the switch point of the valve, in particular for determining the pressure conditions from the current variation of the valve actuating current.

As can be taken from a non-published international patent application filed in parallel to the international patent application at topic, it is principally possible to adjust the pressure gradient or flow G of a corresponding pressure control valve in dependence on the differential pressure by way of the coil current. It is common to the valves employed that the volume flow Q depends, among others, on the differential pressure Δp and on the current I. However, normally this dependency (characteristic curve) is not precisely known because insignificant individual structural deviations of the valves from each other in a line of products, which deviations are induced by manufacture, have already a major effect on the functional interrelationship between flow and drive current. It is therefore necessary to draft characteristic fields for each individual valve what usually necessitates a sophisticated calibration in the plant or at the end of the assembly line at the site of the motor vehicle manufacturer. The determined characteristic fields can then be used, as has been described e.g. in WO 01/98124 A1 (P 9896), to adjust the desired pressure gradient.

The above-mentioned non-published international patent application solves the problem that the methods for determining characteristic curves as known from the state of the art still suffer from an undesirable deviation so that the desired pressure gradient cannot be adjusted with an appropriate rate of precision. This has a negative influence on the control performance of the overall system. Improvement would be achieved in that a calibration of the valves is carried out individually for each manufactured control unit at the supplier's site or at the assembly line. To this end, characteristic curves can be acquired by means of a suitable measuring device, or appropriate individual parameters KG_{ind} being obtained from these characteristic curves, can be transmitted to a controller connected or connectible to the control unit, in particular to an electronic accumulator contained in the controller. However, this method is rather sophisticated and, hence, cost-intense.

According to the above-mentioned, non-published patent application, proposals have been made to perform a more precise actuation of the hydraulic valves described hereinabove without using additional sensor elements or electronic components, and the actual value for the control circuit is provided by a complicated circuit arrangement to measure the time integral by way of the time-responsive induction voltage according to the non-published method, the said induction voltage being an indicator of the magnetic flux which prevails in the inductive component (magnet coil).

### SUMMARY OF THE INVENTION

An object of the invention involves simplifying a circuit arrangement that can be implemented in the above method to measure the integral of an electric quantity for determining the magnetic flux in an inductive component, and further disclosing a method which allows determining the integral in a particularly simple fashion.

This object is achieved by a method for determining the magnetic flux in an inductive component and a circuit arrangement for determining the magnetic flux or inductance of an inductive device.

According to the method of the invention, the magnetic flux is determined in at least one inductive component which is electrically controllable by means of a drive signal using an electronic actuation or driver stage. The method is used to evaluate and adjust a measuring signal induced by the magnetic flux of the inductive component by means of an electronic measuring device. As this occurs, the magnetic-flux-responsive measuring signal measured at the inductive component is actively maintained at a substantially constant value by means of the measuring device or the electronic actuation or the driver stage. Furthermore, the time t₁ or t_{c} is determined during which the drive signal is triggered, which acts on the inductive component with production of the measuring signal.

The measuring signal can be one signal or more signals out of the group of
voltage prevailing at the inductive component,
magnetic flux in the inductive component, or
measuring signal of a measuring element to determine the magnetic flux.

The inductive component is preferably an actuator component which is more particularly an electromagnetically controllable actuator in which an electrically controllable electromagnetic arrangement acts on a mechanical unit to adjust a fluid flow. It is particularly preferred that the actuator is a hydraulic or pneumatic solenoid valve.

Furthermore, calibration characteristic curves or parameters for calibration can be determined for the calibration of valves without using pressurizations of the valve. This obviates, for example, the need for the pressurization during the establishment of the characteristic curves or parameters by means of a pneumatic or hydraulic measuring arrangement, by means of which defined pressure differences at the valve being measured are adjusted according to the state of the art. This provision, among others, achieves the advantage that a manufactured valve or a complete hydraulic unit, unlike previously necessary, does not have to be measured individually in a test bench by using defined pressures.

According to another favorable method of the invention, the inductive component is inductively coupled to one or more additional measuring elements which make available in particular measuring coils for determining a measuring signal. This renders it likewise possible to determine the inductance or any other corresponding magnetic quantity from the inductive voltage or the variation of the disabling current.

### BRIEF DESCRIPTION OF THE DRAWINGS

Further preferred embodiments can be seen in the subsequent description of embodiments by way of Figures.

In the drawings:

FIG. 1 shows an arrangement of a control circuit for the valve calibration with a square-wave forming circuit;

FIG. 2 shows an arrangement corresponding to FIG. 1, however, with a measuring coil for measuring the magnetic flux;

FIG. 3 is a representation of the variation of the voltage and the current in a typical coil actuation of a hydraulic valve; and

FIG. 4 is a schematic view of a circuit arrangement for the simple measurement of the period between the time t₀ and t₁ (square-wave forming circuit).

### DETAILED DESCRIPTION OF THE DRAWINGS

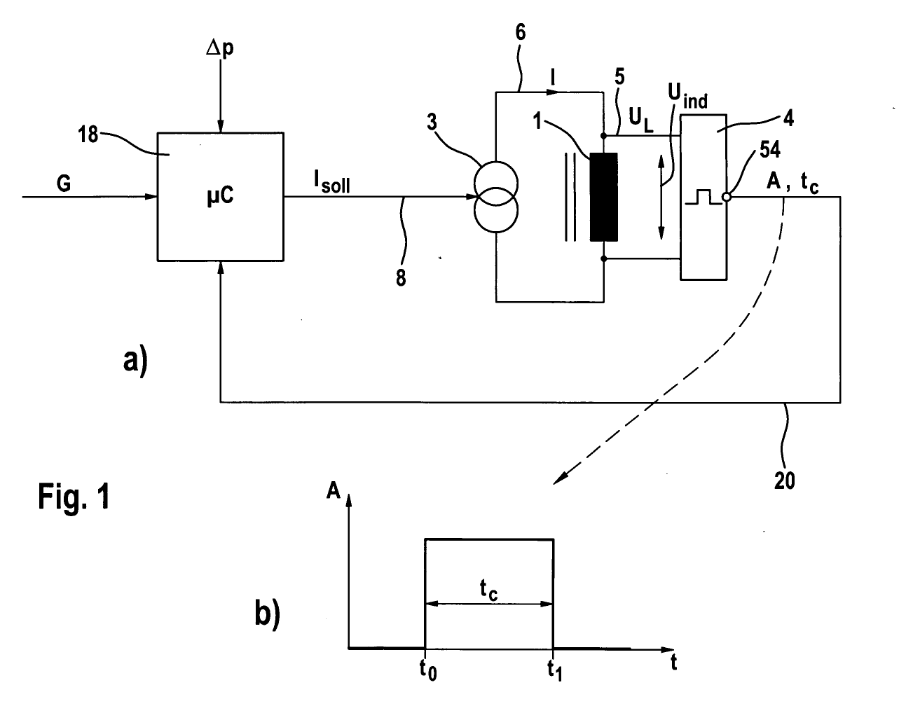

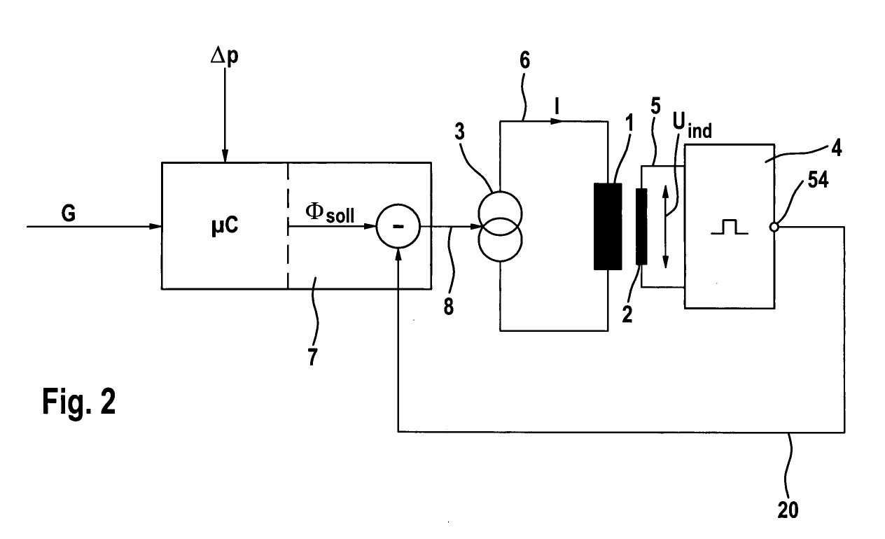

The subsequently described examples are employed in an electrohydraulic control device for passenger vehicle brakes. Typically, corresponding control devices (EBS control unit) comprise a controller housing (ECU) with a microcontroller system 18, represented as a block in FIGS. 1 and 2. The controller housing (not shown) is connected to a hydraulic valve block (HCU) (also not shown) which comprises several solenoid valves containing coils 1 to control the hydraulic flow. Besides the microcontroller system 18, the controller houses a drive circuit in the type of several individually controllable current sources 3 permitting the actuation of the solenoid valves by way of valve current I. Current sources 3 are realized by final stages that adjust the current in a pulse-width-modulated fashion. A square-wave forming circuit 4 is connected to the terminals of the coil 1 by way of electric lines used to measure the induction voltage U_{ind} that occurs with a change in current.

The schematic view in FIG. 2 shows a similar control circuit like FIG. 1, however, the magnetic flux within the exciter coil 1 of the valve is measured by a measuring coil 2 in this case. When the valve coil is enabled and disabled, a voltage U_{ind} is induced in the measuring coil whose integral is proportional to the existing magnetic flux. By way of line 20, the time signal t_{c} which is proportional to the magnetic flux is sent as a controlled variable to the controller 7 shown within the microcontroller system.

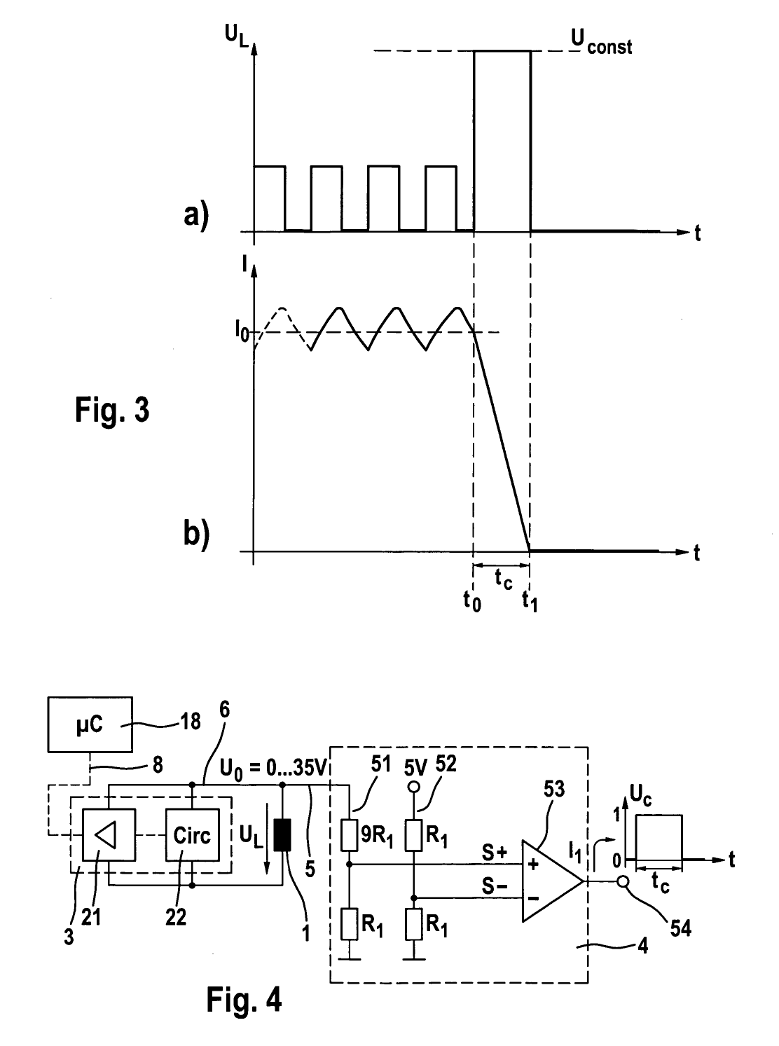

In the example of FIG. 3, a valve coil in the unpressurized condition is disabled after a defined current I₀ is reached, reliably implying that the valve is closed. With a modified driver 21, 22 (FIG. 4), as described in patent application DE 102004017239.0, the current can be commutated in the sense of disabling very quickly (within a time of less than 1 ms) by way of a controllable semiconductor resistance, as can be taken from FIG. 3b. In this arrangement, the terminal voltage can be adjusted variably and very accurately, other than would be the case with integrated zener diodes, for example.

When the valve coil is disabled, the magnetic flux in coil 1 of FIG. 1 induces a voltage U_{L} (terminal voltage) so that the current declines during the disabling operation in a time t_{c} to approximately the value 0. FIG. 3a) depicts the voltage variation at the coil.

The coil resistance R_{L}, the coil voltage U_{L} (constantly adjusted commutation voltage), as well as I₀ (valve current) are known to the electronic controller (ECU). The time t_{c}, which is proportional to the inductance L, is measured by means of square-wave forming circuit 4. The inductance of the coil can be determined from the current variation during the commutation in the sense of disabling between time t₀ and time t₁ according to the formula:

$${u}_{L} = L \cdot \frac{ⅆ i}{ⅆ t} .$$

Due to the special actuation, where U_{L} is maintained constant between times t₀ and t₁, the time integral of the current, which is to be calculated in order to determine the inductance of the coil, becomes especially simple. When the current is zero after the commutation in the sense of disabling, and the ohmic resistance of the coil is not taken into account, the inductance of the valve coil can be determined by way of

$$L = \frac{{u}_{L} \cdot {t}_{c}}{{I}_{0}} .$$

In consideration of the ohmic resistance R_{L}, the inductance can be defined according to the equation

$$L = - \frac{- {t}_{c} \cdot {R}_{L}}{ln ( \frac{{u}_{L}}{{I}_{0} \cdot {R}_{L} + {u}_{L}} )} .$$

Feedback of the signal 20 of the measuring device 4 in microcontroller 18 allows achieving a flow regulation or flow control, which is illustrated in FIGS. 1 and 2. The valve current I which flows through the valve coil 1, represents the correcting variable of the control.

The circuit arrangement in FIG. 4 shows a square-wave forming circuit 4 connected to coil 1 and being driven by final stage 21. Driver stage 3 comprises in addition to final stage 21 an active recirculation circuit 22 for the quick commutation of the coil current in the sense of disabling when the solenoid valve is disabled.

Square-wave forming circuit 4 comprises voltage divider 51, composed of resistors R₁ and 9R₁, voltage divider 52 as well as comparator 53.

Voltage divider 51 reduces the high voltage values U₀ at the signal input S+ of the comparator 53 by the factor 10, in order to be able to work with normal logic levels. Voltage divider 52 generates a reference voltage at the input S− of the comparator 53, which equals half the logic supply voltage. Comparator 53 thus assesses the difference between the signals S+ and S−, with the result that a suitable square-wave signal is produced at output 54. During a per se known pulse-width-modulated control (PWM) of the valve current, the voltage at U₀ rises to a maximum of roughly 18 volt so that the input S+will never exceed 2.5 volt. The output 54 of the comparator thus stays on ‘logical 0’. At the commencement of a commutation in the sense of disabling, however, the voltage U₀ rises to e.g. 35 volt, with the result that S+, being at 3.5 volt then, will be considerably higher than S−. The consequence is a change-over of the comparator to ‘logical 1’ until the voltage U₀ drops again to 0 volt corresponding to the end of the commutation in the sense of disabling. Thereafter, the comparator 53 will change over to ‘logical 0’ again. Thus, the duration of the ‘logical 1’ at the output 54 corresponds precisely to the duration t_{c} of the commutation in the sense of disabling. The comparator signal can be sensed very precisely with respect to time and further processed by means of the microcontroller illustrated in FIG. 1.

It is also possible to determine the magnetic resistance R_{M} of the valve coil by means of the interrelationship

$${R}_{m} = \frac{{N}^{2}}{L} .$$

In the formula indicated, N is the number of windings of the coil, and L represents the inductance which is obtained from the flux corresponding to the above.

With a low starting current I₀, the procedure described can also be used to determine the magnetic resistance of the opened valve.

With the knowledge of spring force and magnetic force (due to the determination of the magnetic resistance), the current to be adjusted for a defined pressure gradient can be determined for a prevailing hydraulic force.

1-10. (canceled)

11. A method for determining magnetic flux in at least one inductive component which is electrically drivable by an electronic actuation or a drive signal, the method comprising:
evaluating and adjusting a measuring signal induced by the magnetic flux of the inductive component using an electronic measuring device (4), wherein the magnetic-flux-responsive measuring signal (5) measured at the inductive component is actively maintained at a substantially constant value by the measuring device; and
determining a time during which a drive signal is triggered, which acts on the inductive component with production of the measuring signal, wherein the measuring signal includes at least one of a voltage prevailing at the inductive component, the magnetic flux in the inductive component, or a measuring signal of a measuring element (2) to determine the magnetic flux.

12. A method according to claim 11, wherein a time t_{c} between an enabling time t₀ and the disabling time t₁ of the drive signal (6) is determined by a circuit arrangement, and the time t_{c} is made available as an electric signal (20) for further processing operations.

13. A method according to claim 11, wherein at least one controller is provided having a correcting variable that acts on the electronic actuation or the driver stage, with the drive signal being formed, and with the current being used by the inductive component as a drive signal.

14. A method according to claim 13, wherein the time or the time signal is used as the controlled variable for the control.

15. A method according to claim 11, wherein the inductive component is an electromagnetic actuator.

16. A method according to claim 11, wherein the inductive component is an analog-controlled solenoid valve within an electrohydraulic system.

17. A method according to claim 11, wherein at least one electromagnetically drivable actuator for controlling a flow of a fluid responsive to a differential pressure, in which the indicator of the influencing of the pressure caused by the actuator can be determined in advance by the intensity of the electric actuation of the actuator even without the use of pressure sensors, in which one or more actuator-related characteristic curves or parameters for the actuator are taken into account so that by means of these parameters a nominal flow can be adjusted in a defined fashion in dependence on the current intensity, and in which the actuator-related parameters are established automatically without using pressurizations of the actuator.

18. An electronic circuit arrangement for determining magnetic flux or inductance of an inductive actor component comprising:
a measuring device having a signal input and a signal output (54), with the signal input being connected electrically to an inductive component (1) or a measuring element (2), and with the output providing an electric signal which contains information as a function of time required to completely discharge magnetic energy stored in the inductive actor component, at a substantially constant voltage.

19. An electronic circuit arrangement according to claim 18, wherein the signal output of the measuring device is sent as an actual value to a control circuit (7) having a controlled variable (8) which is the current through the inductive component.

20. An electronic circuit arrangement according to claim 18, wherein the actor component is driven by a pulse-width-modulated current driver (3).
